(19) United States
(12) Patent Application Publication
(10) Pub. No.: US 2018/0244577 A1
(43) Pub. Date: Aug. 30, 2018

(54) REFRACTORY BRICKS

(71) Applicants: KNAUF INSULATION LIMITED, Merseyside (GB); KNAUF INSULATION DOO SKOFJA LOKA, Slovenia (SI); KNAUF INSULATION SPRL, Vise (BE); KNAUF INSULATION, INC., Shelbyville, IN (US)

(72) Inventor: Stefan KOESSLER, Radenthein (AT)

(21) Appl. No.: 15/755,085

(22) PCT Filed: Aug. 24, 2016
(86) PCT No.: PCT/EP2016/070008

§ 371 Date: Feb. 25, 2018

(30) Foreign Application Priority Data
Aug. 25, 2015 (GB) 1515040.2

(51) Int. Cl. C04B 35/047; C04B 35/043; C04B 35/626; C04B 35/636

(52) U.S. Cl. CPC C04B 35/047; C04B 35/043; C04B 35/6263; C04B 2235/94; C04B 2235/604; C04B 2235/72; C04B 35/636

(57) ABSTRACT

A process for preparing a refractory brick, comprises:
mixing a refractory aggregate and a binder composition to obtain a refractory mixture wherein the binder composition comprises:

(a) carbohydrate reactant(s) comprising reducing sugar(s) or carbohydrate reactant(s) that yield reducing sugar(s) in situ under thermal conditions and nitrogen-containing reactant(s) and/or

(b) curable reaction product(s) of reducing sugar(s) and nitrogen-containing reactant(s)
pressing the refractory mixture to obtain a moulded refractory brick; and
firing the moulded refractory brick.

The present invention relates to refractory bricks and a process for their production.

According to one aspect, the present invention provides a method of manufacturing a refractory material as defined in claim 1. Additional aspects are defined in other independent claims. The dependent claims define preferred or alternative embodiments.

The binder composition is advantageous in providing a good mixability with the aggregate material and avoiding stickiness problems on the press that can be observed with common dextrin binders. It also provides good green strength of the pressed but unfired refractory blocks and does not present a problem of sulphur emission observed with lignosulfonate binders.

A refractory brick is a block of refractory ceramic material used, for example, in lining furnaces, kilns and fireboxes. A refractory brick is built primarily to withstand high temperature, but will also usually have a reasonably low thermal conductivity for greater energy efficiency. Many refractory bricks are rectangular but the term refractory brick as used herein is not limited to any particular shape.

The binder composition is preferably “substantially formaldehyde free”, that is to say that it liberates less than 5 ppm formaldehyde as a result of drying and/or possible curing (or appropriate tests simulating drying and/or curing); it is preferably “formaldehyde free”, that is to say that it liberates less than 1 ppm formaldehyde in such conditions.

The binder composition may comprise a binder composition as described in any of WO 2007/014236, WO 2009/019232, WO 2009/019235, WO 2011/138458, WO 2011/138459 or WO 2013/150123 each of which is hereby incorporated by reference.

The carbohydrate reactant(s) may comprise reducing sugar(s) or it may comprise one or more reducing sugars generated in situ, for example under application of heat and/or presence of a catalyst or further reactant. The nitrogen-containing reactant(s) of the binder composition are adapted to react with the reducing sugar(s) to form a binder and/or to form binder precursors.

The binder composition may comprise: (a) unreacted carbohydrate reactant(s) comprising reducing sugar(s) or carbohydrate reactant(s) that yield reducing sugar(s) in situ under heating or firing conditions and unreacted nitrogen-containing reactant(s); or (b) reaction product(s) resulting from the reaction between reducing sugar(s) and nitrogen-containing reactant(s); or (c) a combination of (a) and (b).

The nitrogen-containing reactant(s) and the carbohydrate reactant(s) (or their reaction product(s)) may be Maillard reactants that react to form Maillard reaction products, notably melanoidins when cured. Any curing of the binder may comprise or consists essentially of Maillard reaction(s). The cured or fired binder may comprise melanoidin-containing and/or nitrogenous-containing polymer(s); it is preferably a thermoset binder and is preferably substantially water insoluble.

The binder compositions containing reaction product(s) resulting from the reaction between nitrogen containing reactant(s) and reducing sugar reactant(s) prior to any curing or firing (notably prior to crosslinking by application of heat and or pressure) may comprise intermediate reaction specie(s), for example pre-polymers. Preferably, the binder composition when mixed with the refractory aggregate comprises at least 50% by dry weight of reaction products of nitrogen containing reactant(s) and reducing sugar reactant(s), more preferably at least 60%, at least 70% or at least 80%. The solid content of the binder composition when mixed with the refractory aggregate may consist essentially of reaction products of nitrogen containing reactant(s) and reducing sugar reactant(s).

The reducing sugar may comprise a monosaccharide in its aldose or ketose form. The reducing sugar may comprise: a disaccharide, a polysaccharide, a triose, a tetrose, a pentose, xylose, a hexose, dextrose, fructose, a heptose, a sugar, molasses, starch, starch hydrolysate, cellulose hydrolysates, reaction product(s) thereof or mixtures thereof. The carbohydrate reactant may have a dextrose equivalent of at least about 50, at least about 60, at least about 70, at least about 80 or at least about 90; where a plurality of carbohydrate reactants are present, any of the carbohydrate reactants may have such a dextrose equivalent.

The nitrogen-containing reactant may comprise ammonia solution, NH₃, inorganic amine(s), organic amine(s) comprising at least one primary amine group, salts thereof and combinations thereof. For example, the nitrogen-containing reactant may comprise NH₃ (e.g. in the form of an aqueous solution), inorganic and/or organic ammonium salts, ammonium sulphate, ammonium phosphate, ammonium chloride, ammonium nitrate, ammonium citrate and combinations thereof. The nitrogen-containing reactant may comprise a polyamine; it may comprise a primary polyamine. Herein, the term “polyamine” includes any organic compound having two or more amine groups, which may independently be substituted. As used herein, a “primary polyamine” is an organic compound having two or more primary amine groups (—NH₂). Within the scope of the term primary polyamine are those compounds which can be modified in situ or isomerize to generate a compound having two or more primary amine groups (—NH₂). In one embodiment, the polyamine may be a molecule having the formula of H₂N-Q-NH₂, wherein Q is an alkyl, cycloalkyl, heteroalkyl, or cycloheteroalkyl, each of which may be optionally substituted. In one embodiment, Q is an alkyl selected from a group consisting of C₂-C₂₄. In another embodiment, Q is an alkyl selected from a group consisting of C₂-C₈. In another embodiment, Q is an alkyl selected from a group consisting of C₃-C₇. In yet another embodiment, Q is a C₆ alkyl. In one embodiment, Q is selected from the group consisting of a cyclohexyl, cyclopentyl or cyclobutyl. In another embodiment, Q is a benzyl. The primary polyamine may be a diamine, for example a di-primary diamine. The primary polyamine may be a triamine, tetraamine, or pentamine. The polyamine may comprise a diamine selected from 1,2-diaminoethane, 1,4-diaminobutane, 1,5-diaminopentane, 1,6-diaminohexane (hexamethylenediamine, HMDA), 1,12-diaminododecane, 1,4-diaminocyclohexane, 1,4-diaminobenzene, 1,5-diamino-2-methylpentane (2-methyl-pentamethylenediamine), 1,3-pentanediamine, and 1,8-diaminooctane. The nitrogen-containing reactant may comprise a primary polyamine polyether-polyamine; said polyether-polyamine may be a diamine or a triamine.

Preferably, the binder composition when mixed with the refractory aggregate is substantially free of ammonia in solution; this prevents undesired ammonia emissions.

The carbohydrate reactant(s), may make up:
at least 30%, preferably at least 35%, preferably at least 40%, more preferably at least 45%, more preferably at least 50%, even more preferably at least 60% by dry weight of the binder composition; and/or
less than 99%, preferably less than 98%, more preferably less than 97% by dry weight of the binder composition.

The nitrogen-containing reactant(s) may make up:
less than 50%, preferably less than 45%, more preferably less than 40%, even more preferably less than 25% by dry weight of the binder composition; and/or
at least 0.5%, preferably at least 1%, more preferably at least 3%, even more preferably at least 5% by dry weight of the binder composition.

The term “dry weight of the binder composition” as used herein means the weight of all components of the binder composition other than any water that is present (whether in the form of liquid water or in the form of water of crystallization).

An advantage of some embodiments of the binder composition of the invention is that they have substantially no sulphur emission during the process compared to known and commonly used calcium and sodium lignosulfonate binder. Binder composition of the invention may have substantially no ammonia emissions during the process.

The binder composition may further comprise one or more additives, for example dyes, antifungal agents, antibacterial agents, hydrophobes, silane compounds, dedust oil and/or other additives, as may be appropriate. These additives are selected such as not to detract from the adhesive properties of the binder nor the mechanical and other desired properties of the final product.

The binder composition may be a solid binder composition; this may facilitate mixing with a refractory aggregate, notably under dry conditions.

The binder composition may be a solution or dispersion, notably an aqueous solution or dispersion. As used herein, the term “aqueous solution or dispersion” relates to a solution and/or dispersion in which water may make up at least 50%, preferably at least 60%, more preferably at least 70%, more preferably at least 80%, even more preferably at least 90% by volume on the total volume of the solvent. Said term further includes compositions or mixtures which contain water and one or more additional solvents. An “aqueous binder composition” of the invention may be a solution or partial solution of one or more of said binder components or may be a dispersion, such as an emulsion or suspension.

Where an aqueous binder composition which is to be mixed with the refractory aggregate (before any pressing and firing) is produced by mixing components of the binder composition with water, the amount of water may make up:
≥5 w %, preferably ≥10 w %, more preferably ≥15 w %; and/or
≤60 w %, preferably ≤55 w %, more preferably ≤50 w %;
   based upon the total weight of the aqueous binder composition.

The aqueous binder composition, when it is mixed with the refractory aggregate, before any pressing and firing, may have a solid content of:
greater than or equal to: 30% or 35% or 40% or 45% or 50% or 55% or 60%;
   and/or
less than or equal to: 85% or 80% or 75% or 70% or 65%;
   determined as bake out solids by weight, for example after drying at 140° C. for 2 hours.

The components of the binder composition may be transported separately and combined shortly before use in the relevant manufacturing plant. It is also possible to transport the binder composition as such.

Firing of the moulded refractory brick may occur at a temperature ≥1000° C., notably 1200° C. Particularly in this case, firing of the moulded refractory bricks may involve formation of ceramic bonding between the refractory particles and/or partial softening or partial melting of the refractory particles and/or formation of a carbon skeleton, notably from the binder composition. The binder compositions of the invention may be used to provide green strength to refractory bricks, for example prior to the bricks being raised to their operating temperature; particularly in this case, firing of the refractory bricks may occur at a temperature ≥100° C. and/or ≤350° C. or ≤300° C. Firing may comprise a single heating process or a series of heating processes each separated by a cooling process.

The refractory brick, notably prior to firing, may have a quantity of binder composition which is ≥0.5 w %, or ≥0.75 w % or ≥1 w % and/or ≤5 w %, ≤4 w %, ≤3 w % or ≤2 w % as measured by loss on ignition i.e. by heating the refractory brick to decompose the binder composition and comparing the weight of the refractory brick with and without the presence of the binder composition.

The refractory aggregate may comprise magnesite, dolomite, alumina, oxides, bauxite, quartz, carbonates, ores, clay, silica, chromite and combination thereof.

Depending on the composition of the refractory aggregate different refractory bricks may be obtained. The obtained refractory bricks may be silica bricks, fireclay bricks, high-alumina bricks, chrome-corundum bricks, zircon mullite bricks, zircon silicate bricks, magnesia bricks, calcium aluminate. Their main component may be silica, calcium oxide, alumina, ferric oxide, chromia, zirconia, magnesia. Depending of their composition, their fields of application are different. The refractory bricks may be used in the roof and superstructure of glass melting tanks as well as for hot repairs, or they may be used as rear layers in the superstructure, or in hot areas in glass melting tanks, or as an inert intermediate layer, or in regenerator checkerwork and walls.

Common production of shaped and fired refractory bricks comprises the steps of:
mixing the binder and additives with the crushed raw materials
pouring the mixture into a mould to form shapes (bricks) and pressing, for example with a pressing force up to 2200 tons
drying the formed bricks. In this stage water is removed from the shaped bricks. This helps preventing the bricks from deforming or cracking which may result from uncontrolled rapid evaporation
firing of the formed bricks in tunnel kilns, for example with temperature between 1500° C. and 1800° C. to accomplish ceramic bonding. In addition to the firing temperature, the heating and cooling times as well as the atmosphere in the kiln are of importance. The binder burns off and the aggregates sinter at the aforementioned temperatures.
brick after-treatment may take place in the form of cutting, grinding and impregnation.
   One or more of these steps may be used in the present invention.

The invention will be explained in more details in the non-limiting examples below.

An aqueous binder composition was prepared by adding HMDA (192.86 g; 70 w % in H₂O) to 1163.37 g of dextrose monohydrate (DMH 90.9 w % dextrose and 9.1 w % water of crystallisation) and 1057.50 g of fructose (FRU; 100% solid) and 586.28 g of water. This binder composition corresponds to 47:47:6 w % DMH:FRU:HMDA at a 75 wt.-% in H₂O.

### EXAMPLE 1:

1000 kg of binder impregnated refractory aggregate material was prepared by blending i) a magnesia aggregate (MgO, 100%, grain size 0.3-0.4 mm) ii) 20 kg of the above aqueous binder composition iii) 4 kg of water and iv) magnesia powder (MgO, 100%, grain size <0.3 mm). The mixture was mixed and then pressed (251.3*252.5*90-114 mm, l*w*t “wedged”, length*width*thickness) with a pressure up to 150 N/mm² and a cycle time of 25 s/per stone. Between 35 and 40 stones were obtained.

### EXAMPLE 2:

1000 kg of binder impregnated refractory aggregate material was prepared by blending i) a magnesia aggregate (60% MgO, 40% Chrome-ore, grain size 0.3-0.4 mm) ii) 20 kg of the above aqueous binder composition iii) 2 kg of water and iv) magnesia/Chrome-ore powder (60% MgO, 40% Chrome-ore, grain size <0.3 mm). The mixture was mixed and then pressed (251.3*252.5*90-114 mm, l*w*t “wedged”, length*width*thickness) with a pressure up to 150 N/mm² and a cycle time of 25 s/per stone. Between 35 and 40 stones were obtained.

The mixing of the batches went without any issues and were comparable to lignosulfonate binder. The pressing occurred without any problems and the green strength was good.

1. A process for preparing a refractory brick, comprising
mixing a refractory aggregate and a binder composition to obtain a refractory mixture wherein the binder composition comprises:
(a) carbohydrate reactant(s) comprising reducing sugar(s) or carbohydrate reactant(s) that yield reducing sugar(s) in situ during firing and nitrogen-containing reactant(s) and/or
(b) reaction product(s), notably curable reaction products, of reducing sugar(s) and nitrogen-containing reactant(s)
pressing the refractory mixture to obtain a moulded refractory brick; and
firing the moulded refractory brick.

2. A process in accordance with claim 1 wherein the binder composition is a solid binder composition.

3. A process in accordance with claim 1 wherein the binder composition is an aqueous binder composition having a solid content in the range of 40 wt % to 85 wt % determined as bake out solids by weight after drying at 140° C. for 2 hours.

4. A process in accordance with claim 1 wherein the binder composition is substantially formaldehyde free.

5. A process in accordance with claim 1 wherein the process is substantially free of ammonia emission.

6. A process in accordance with claim 1 wherein the process is substantially free of sulphur emission.

7. A process in accordance with claim 1 wherein moulded refractory brick, prior to firing, comprises between 0.5 wt % and 5 wt % of the binder composition measured by loss on ignition.

8. A process in accordance with claim 1 wherein the binder composition comprises
(i) between 50% to 99% by dry weight, preferably between 75% to 95 by dry weight of carbohydrate reactant(s) comprising reducing sugar(s) and/or carbohydrate reactant(s) that yield reducing sugar(s) in situ during firing; and
(ii) between 1% to 50% by dry weight, preferably between 5% to 25% by dry weight, of nitrogen-containing reactant(s).

9. A process in accordance with claim 1 wherein the binder composition when mixed with the refractory aggregate comprises at least 50% by dry weight of reaction products of nitrogen containing reactant(s) and reducing sugar reactant(s).

10. A process in accordance with claim 1 wherein the nitrogen-containing reactant(s) are selected from the group consisting of a primary amine, a di-primary diamine, HMDA and combinations thereof.

11. A process in accordance with claim 1 wherein the carbohydrate reactant(s) are selected from the group consisting of dextrose, fructose, xylose, and mixtures thereof.

12. A process in accordance with claim 1 wherein the refractory aggregate comprises magnesite, dolomite, alumina, oxides, bauxite, quartz, carbonates, ores, clay, silica, chromite, and combination thereof.

13. A refractory brick obtained by the process of claim 1.
